(19) United States
(12) Patent Application Publication
(10) Pub. No.: US 2023/0037008 A1
(43) Pub. Date: Feb. 2, 2023

(54) Tongs

(71) Applicant: TCG Partners LLC - Intellectual Property Series, Houston, TX (US)

(72) Inventors: Hunter Ryan Jaggard, Katy, TX (US); Griffin Tyler Jaggard, Katy, TX (US); Stephen Paul Dunn, Houston, TX (US); Stephen Hunter Jaggard, Houston, TX (US)

(21) Appl. No.: 17/388,706

(22) Filed: Jul. 29, 2021

Related U.S. Application Data
(63) Continuation-in-part of application No. 29/801,420, filed on Jul. 28, 2021.

(51) Int. Cl. A47J 43/28

(52) U.S. Cl. CPC A47J 43/283

(57) ABSTRACT

A lockable food handling apparatus provides ease of use to users. The apparatus includes a pair of arms each having a respective engagement member and end. The arms are affixed at a pivot point defined at a fastening point adjacent the ends of the pair of arms. A spring mechanism is positioned between the two arms which applies a linear force to the first arm and the second arm. Affixed to an inner surface of one of the pair of arms is a track that includes a retaining element positioned adjacent the ends of the pair of arms. Due to a difference in length of the ends of the pair of arms, one of the ends may engage the retaining element when the ends of the pair of arms are pivoted toward the retaining element, thus placing the apparatus into a reversible locked state.

### FIELD OF THE INVENTION

The disclosure relates generally to food handling apparatuses, and more specifically to orientation-based lockable tongs.

### BACKGROUND OF THE INVENTION

Tongs are a well-known device for handling food in kitchen and cooking settings. More specifically, tongs are known to be used in tandem with a grilling device. When cooking with meats or any type of food that needs to be turned over, tongs are a viable option as a food engagement tool. Oftentimes, tongs include a pair of arms and a mechanism applying some type of tension force to each arm of the pair of arms.

Due to their spring-loaded/pivoting nature, the arms of tongs are typically spread apart by default. This mechanism may reduce the storage ability of the tongs as well as simplify the usage of the tongs. In addition, if tongs are designed to close and become more compact, the mechanisms utilized usually take more than one hand to close them. In the cooking universe, a simple, improved, and easily controllable retaining mechanism is needed to allow more control over unexpected movements carried out by most tongs.

### BRIEF SUMMARY OF THE INVENTION

The disclosed subject matter provides a food handling apparatus, or tongs, including an orientation-based locking mechanism. The apparatus comprises a first arm and a second arm each having an end and an engagement member opposite one another. Each of the arms may be affixed to one another adjacent the first and second ends via a fastening device including an axis (pivot axis) that spans all or some of the width of the food handling apparatus. In order to fasten the arms together, one of the first and second arms may be positioned within the respective other of the first and second arms so that arms may pivot about fastening device/axis. Outer coverings may be positioned on an outside surface of the arms and may be utilized as a gripping area for a user.

A spring mechanism may be positioned about the fastening device between the first and second arms. In this configuration, the spring mechanism may apply a linear force to the arms, creating a biasing force that spreads apart first and second arms at an end of the apparatus opposite the spring mechanism to create a default “open” position for the apparatus. A locking mechanism may be activated based on the orientation that the food handling apparatus is being held in by a user. The locking mechanism keeping the apparatus in a locked state may include a first end, second end, fastening device, track, and retaining element. A track may be affixed to at least one of an inner surface of the first and second arms.

A method is provided for producing a pair of tongs. The method includes forming a pair of arms in a mold via casting (in a mold) or stamping (using tool and die methods). Each arm of the pair of arms being formed may include an end and an engagement member. In embodiments, forming may include forming a flat bottom surface shape for the first and second ends. The pair of arms may be affixed together by a fastening device at a pivot axis (positioned at fastening device and spanning the width of the tongs) positioned adjacent the first end and the second end. When formed, a respective one of the first and second arms may be formed with a length greater than the other of the respective other one of the first and second arms so that one of the first end and the second end may engage retaining element when the arms are pivoted.

The method may further include positioning a spring mechanism about the pivot axis. The spring mechanism may apply a linear force to the interior surfaces of first and second arms so that the arms and ends may separately pivot around the pivot axis. Additionally, a pivot limiting mechanism may be positioned within the pair of arms. The pivot limiting mechanism may include a respective one of the first and second ends, a track affixed to an inner surface of a respective one of the first and second arms, and a retaining element positioned on track that work in congruence to restrict pivoting movement of the arms.

A method is further provided for locking a food handling apparatus. The method includes providing a food handling apparatus having a first arm, a second arm, and a spring mechanism holding the arms in tension. Each of the arms may include an engagement member and an end. The food handling apparatus may then be held by a user so that the engagement members point upward and the pair of ends point downward in relation to the ground. A compressive force may then be applied to the first arm and the second arm opposite that of the tension force provided by the spring mechanism. In this instance, applying the compression may allow a retaining element to position itself in a locking position so that the pair of ends compress and hold the retaining element in place. It is noted that the compression of the retaining element allows the food handling apparatus to stay positioned in a locked position irrespective of how the food handling apparatus is positioned thereafter and whether the compressive force is continually applied to the first and second arms.

An additional method may include unlocking a food handling apparatus. The method includes providing a food handling apparatus having a first arm, a second arm, and a spring mechanism holding the first arm and second arm in tension. Each of the arms may include an engagement member and an end. Within the apparatus, a retaining element is positioned in a locking position so that the pair of ends compress and hold the retaining element in place. The food handling apparatus may then be held by a user so that the engagement members point downward and the pair of ends point upward in relation to the ground. A compressive force may then be applied to the first arm and the second arm opposite that of the tension force provided by the spring mechanism. In this instance, applying the compression may disengage the pair of ends from the retaining element which may allow the spring mechanism to automatically position the food handling apparatus in an open position irrespective of how the apparatus is positioned thereafter and whether the compressive force is continually applied to the first and second arms.

### BRIEF DESCRIPTION OF THE DRAWINGS

The disclosed subject matter, objectives, and advantages thereof, will best be understood by reference to the following detailed description of an illustrative embodiment when read in conjunction with the accompanying drawings, wherein:

FIG. 1 displays a perspective view of a food handling apparatus in a closed position, as shown and described herein.

FIG. 2 displays a perspective view of a food handling apparatus in an open, as shown and described herein.

FIG. 3A displays a partially deconstructed side view of an engaged food handling apparatus, as shown and described herein.

FIG. 3B displays a zoomed-in view of a portion of a partially deconstructed side view of an engaged food handling apparatus, as shown and described herein.

FIG. 4A displays a partially deconstructed side view of a disengaged food handling apparatus, as shown and described herein.

FIG. 4B displays a zoomed-in view of a portion of a partially deconstructed side view of a disengaged food handling apparatus, as shown and described herein.

FIG. 5A displays a partially deconstructed side view of a disengaged and open food handling apparatus, as shown and described herein.

FIG. 5B displays a zoomed-in view of a portion of a partially deconstructed side view of a disengaged and open food handling apparatus, as shown and described herein.

FIG. 6 displays a partially deconstructed side view of a disengaged, upside down, and open food handling apparatus, as shown and described herein.

FIG. 7A displays a partially deconstructed side view of a reengaged food handling apparatus, as shown and described herein.

FIG. 7B displays a zoomed-in view of a portion of a partially deconstructed side view of a reengaged food handling apparatus, as shown and described herein.

FIG. 8 displays a method for producing a pair of tongs, as shown and described herein.

FIG. 9 displays a method for locking a food handling apparatus, as shown and described herein.

FIG. 10 displays a method for unlocking a food handling apparatus, as shown and described herein.

### DETAILED DESCRIPTION

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

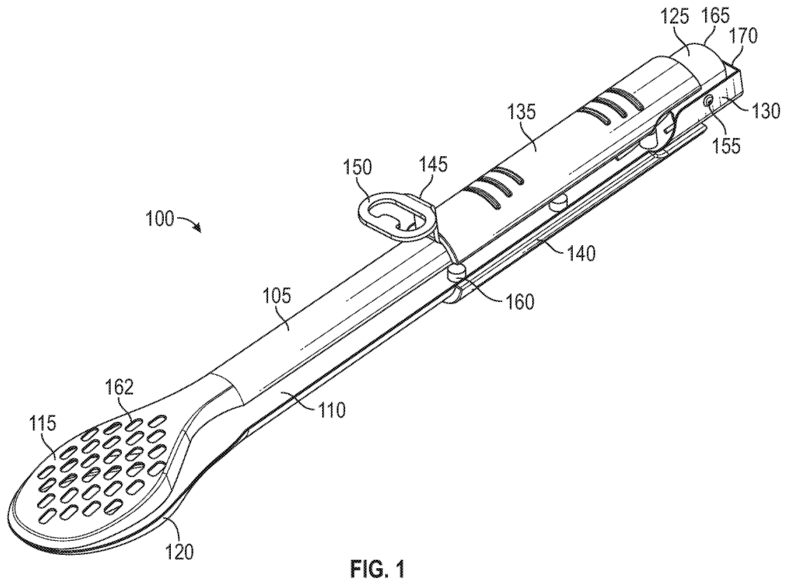

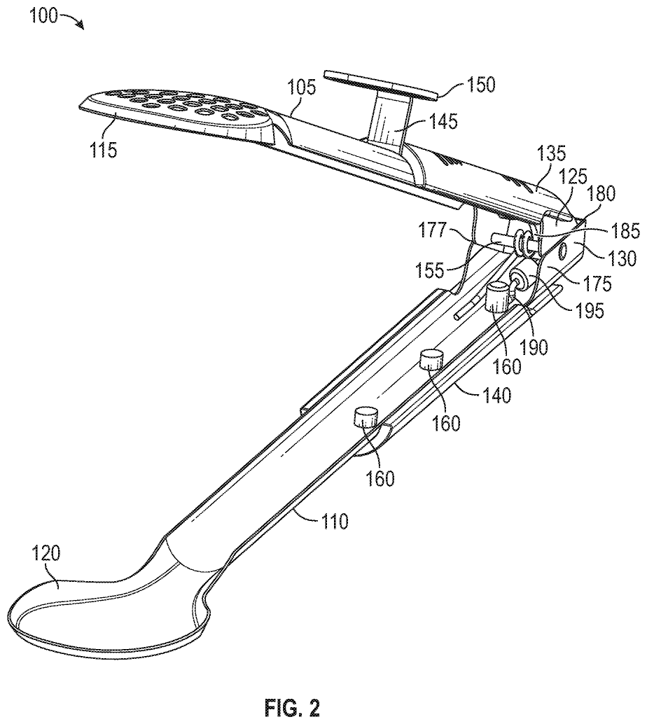

FIG. 1 displays a perspective view of a food handling apparatus 100 in a closed position. The food handling apparatus 100 may comprise a first arm 105 having a first end 125 and a first engagement member 115 opposite the first end 125 and a second arm 110 having a second end 130 and a second engagement member 120 opposite the second end 130. Each of the arms 105,110 may be affixed to one another adjacent the first and second ends 125,130 via fastening device 155 including an axis (pivot axis) that spans the width of the food handling apparatus 100 (see FIG. 2). First and second ends 125,130 may each comprise respective end bottoms 165,170 that may, in embodiments, be flat. It is noted that the position of pivot axis/affixing point of the arms may be thought of as being at least one of adjacent first and second ends 125/130 and at first and second ends 125/130.

In order to fasten the arms 105,110 together, one of the first and second arms 105,110 may be positioned within the respective other of the first and second arms 105,110 so that arms 105,110 may pivot about fastening device 155/axis when the food handling apparatus 100 is in an open position. First outer cover 135 and second outer cover 140 may be positioned on an outside surface of respective arms 105,110 and may be utilized as a gripping area by a user. In embodiments, first and second outer covers 135,140 may comprise at least one of a polymer, a wood, a metal, and a ceramic. In the case where first and second outer covers 135,140 are used more for gripping, embodiments of first and second outer covers 135,140 may comprise more elastomeric properties.

In certain embodiments, the food handling apparatus 100 may comprise stoppers 160. Stoppers 160 may be positioned on the inner surface of at least one of first and second arms 105, 110 so that the stoppers 160 may further limit the pivoting of the first and second arms 105,110 in an inward direction. Typically, stoppers 160 may be made of some sort of polymer, particularly with a high elasticity, so that reverberation from the impact of pressing the first and second arms 105,110 together does not bother or injure a user of the food handling apparatus 100.

For convenience purposes, a bottle opener 150 may be affixed to apparatus 100 via bottle opener neck 145 retainable in a friction fit between at least one of a pair of first arm 105 and first outer cover 135 and second arm 110 and second outer cover 140. In other embodiments, bottle opener neck 145 may be more permanently affixed to at least one of first arm 105, second arm 110, first outer cover 135, and second outer cover 140 using at least one of the following affixing means: male-female engagement, fastening means, adhesives, welding, and magnets.

In certain embodiments, such as that shown in FIG. 1, engagement members 115,120 may each comprise a plurality of orifices 162. Orifices 162 may be useful to drain water out of engagement members 115,120 when using the food handling apparatus 100 in a setting where water, grease, or other liquid is being used to cook food.

FIG. 2 displays a perspective view of a food handling apparatus 100 in an open position. A spring mechanism 185 may be positioned about fastening device 155 between the first arm 105 and the second arm 110. In this configuration, spring mechanism 185 may apply a linear force to first arm 105 and second arm 110, creating a biasing force that spreads apart first arm 105 and second arm 110 at an end of apparatus 100 opposite spring mechanism 185 to create a default “open” position for apparatus 100. It is noted that apparatus 100 may comprise more than one stopper 160 in order to provide additional reinforcement when arms 105,110 are compressed. It is noted that the “open” position may be referred to as the “disengaged” position.

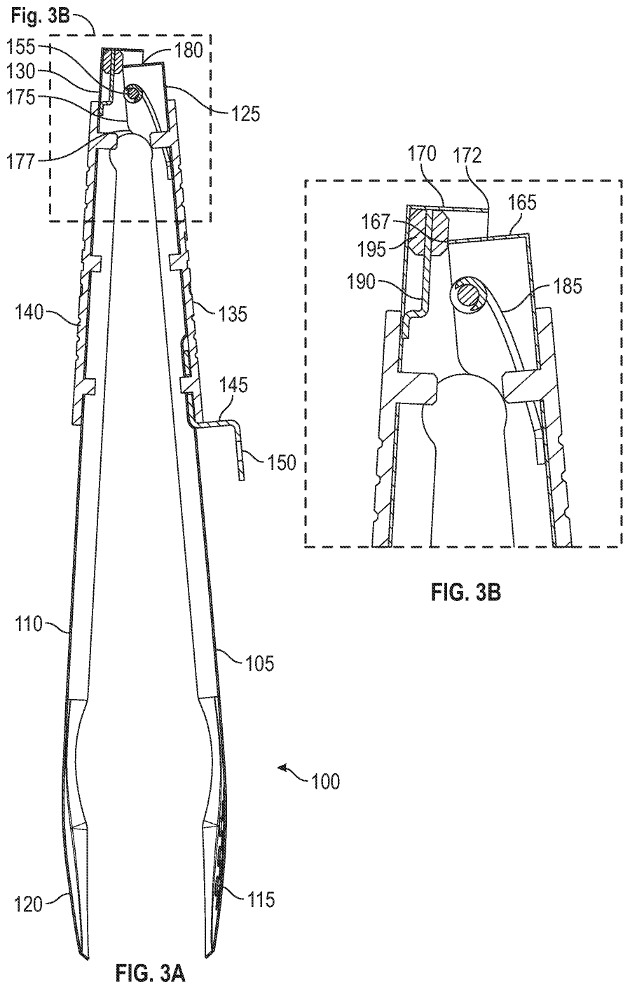

For simplicity, the food handling apparatus 100 may be thought of as having an upper pivot area 175 and a lower pivot area 180, as shown in FIG. 2. Upper pivot area 175 may include first end 125 and second end 130 pivoting around a fastening device 155 perpendicular to the length of a locked food handling apparatus 100 (such as that shown in FIGS. 3A and 3B). Lower pivot area 180 may include first arm 105 and second arm 110 (not including first end 125 and second end 130) pivoting around fastening device 155 perpendicular to the length of locked food handling apparatus 100. It is noted that engagement of the retaining element 195 may occur in the lower pivot area 175.

FIG. 3A displays a partially deconstructed side view of an engaged food handling apparatus 100. In FIG. 3B, a more detailed view of a locking mechanism that may be activated based on the orientation that the food handling apparatus 100 is being held in by a user (orientation-based locking mechanism). As shown, the food handling apparatus 100, in this configuration, may be referred to as being in a locked state. The locking mechanism keeping apparatus 100 in a locked state may include first end 125, second end 130, fastening device 155, track 190, and retaining element 195. Track 190 may be affixed to at least one of an inner surface of a respective one of the first arm 105 and the second arm 110 and a respective one of the first end 125 and the second end 130 (see FIGS. 3A and 3B). For simplicity, it is noted that track 190 may be affixed to at least one of an inner surface of first arm 105 and second arm 110.

When in a locked position, one of the first end 125 and second end 130 may engage retaining element 195 (leading to the interior of the other of the respective first end 125 and second end 130 engaging retaining element 195). This interaction counters the linear force applied to first arm 105/first end 125 and second arm 110/second end 130 by spring mechanism 185 and keeps apparatus 100 in a locked state without the intervention of a user applying a compressive force to apparatus 100. In the locked position, apparatus 100 may stay engaged regardless of what direction a user is holding apparatus 100 in relation to the ground. It is noted that in order to carry out the engagement of retaining element 195, first end bottom 165 and second end bottom 170 may be offset so that when first end 125 and second end 130 pivot, one of the first end 125 and second end 130 directly engages retaining element 195 with one of first end edge 167 and second end edge 172. The other of the first end edge and second end edge may cover and hang over one of the aforementioned edges 167,172 when apparatus 100 is in a locked position. It is noted that in the configuration of apparatus 100 shown in FIGS. 3A and 3B, a respective one of the first end 125 and the second end 130 provides a compressive force to retaining element 195 to prevent movement of retaining element 195.

In embodiments, the food handling apparatus 100 may be considered to be in the locked position when a respective one of the first end 125 and the second end 130 pivots toward the respective other one of the first end 125 and the second end 130 to press against retaining element 195.

It is noted that in embodiments, fastening device 155 may delineate arms 105,110 from ends 125,130. In this case, it may be noted that track 190 may be affixed to one of the pairs of first arm 105 and first end 125 and second arm 110 and second end 130. In other embodiments, shearing area 177 may delineate arms 105,110 from ends 125,130. In this case, it may be noted that track 190 may only be affixed to one of first end 125 and second end 130. It is further noted that shearing area 177 may refer to the area where arms 105,110/ends 125,130 pivotably overlap when apparatus 100 is in use.

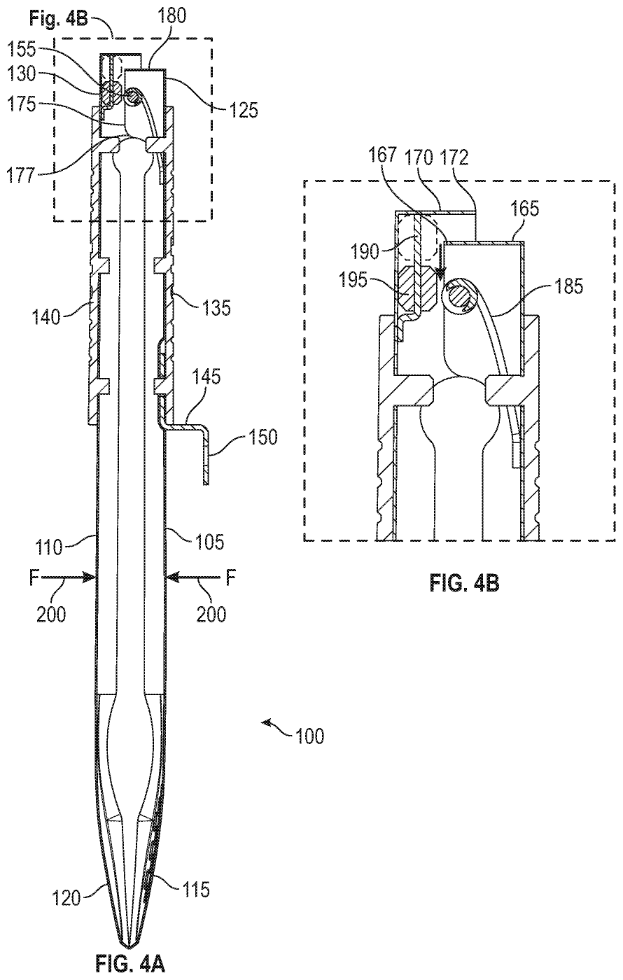

FIG. 4A displays a partially deconstructed side view of a disengaged food handling apparatus 100. FIG. 4B shows a more detailed view of a locking mechanism (portrayed as track 190 and retaining element 195) that may be activated based on the orientation that the food handling apparatus 100 is being held in by a user (in relation to the ground). As shown, the food handling apparatus 100, in this configuration, may be referred to as being in a compressed state while also being held, with engagement members 115,120, pointing to the ground. When compressive force 200 is applied to apparatus 100 (typically by a user), arms 105,110 and ends 125,130 may be positioned along a linear axis (along the length of apparatus 100). It is in this orientation and linear positioning that the food handling apparatus 100 is capable of becoming locked, without the need from external intervention (besides the hand of the user that is holding the food handling apparatus 100). When in this position, second end 125 may disengage retaining element 195 so that retaining element 195 may be pulled from a stationary position into a second position where it is not engageable by either of the first or second ends 125,130. In order for this function to occur, gravity may pull retaining element 195 downward so that it (retaining element 195) slides down track 190 to a second position (or unlocked position). This action allows the spring mechanism 185 to act upon the food handling apparatus 100 to create a greater degree of freedom for both the first and second arms 105,110.

It is noted that track 190 comprise a pole-like configuration while retaining element 195 comprises a toroidal configuration. Due to the specific circumnavigational engagement of track 190 with retaining element 195, retaining element 195 may easily slide from one position to another along track 190. In addition, this configuration may provide minimal points of contact between track 190 and retaining element 195, making this locking mechanism less prone to potential frictional stagnation and/or stuckness when compared to locking mechanisms with multiple points of contact.

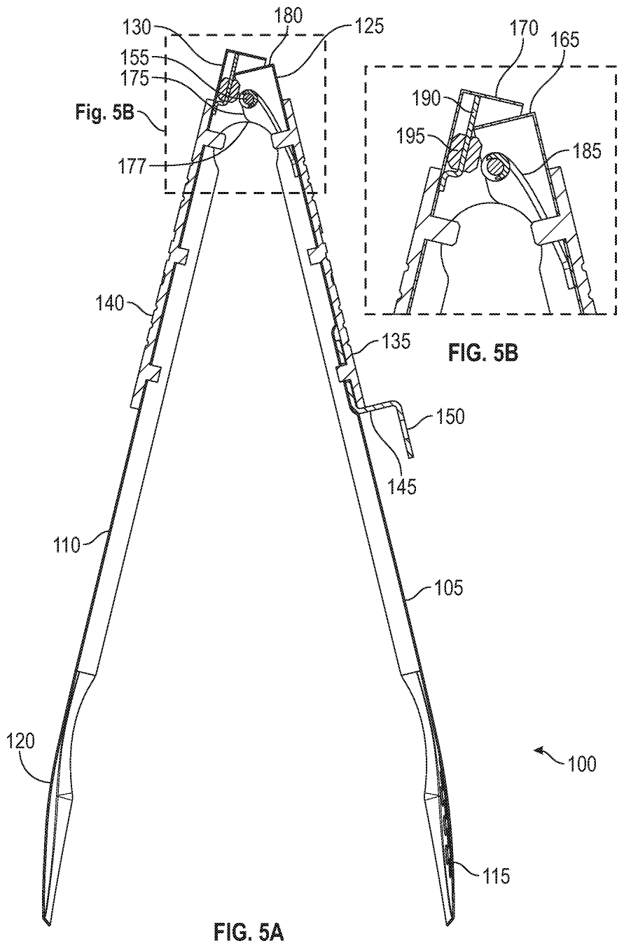

FIG. 5A displays a partially deconstructed side view of a disengaged and open food handling apparatus 100. FIG. 5B shows a more detailed view of the locking mechanism, and more specifically shows retaining element 195 resting in a second position below the pivoted first and second ends 125,130. As shown, the food handling apparatus 100, in this configuration, may be referred to as being in an open state. Once retaining element 195 clears the pivoting path of first and second ends 125,130, first end edge 167 may continue to pivot until it engages track 190 (above the second position of retaining element 195). In this state, arms 105,110 and ends 125,130 may be freely pivotable about pivot axis (defined by fastening device 155) unless apparatus 100 is turned upside down (ends 125,130 facing the ground) and compressed. This may lead to the retaining element 195 being engaged by first end edge 167, which would stop the pivoting of arms 105,110 and ends 125,130.

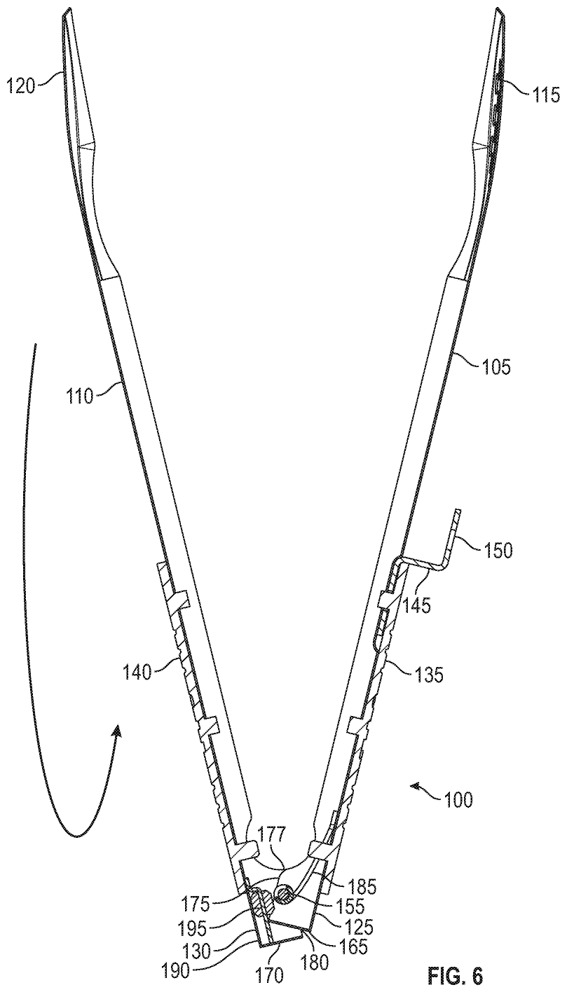

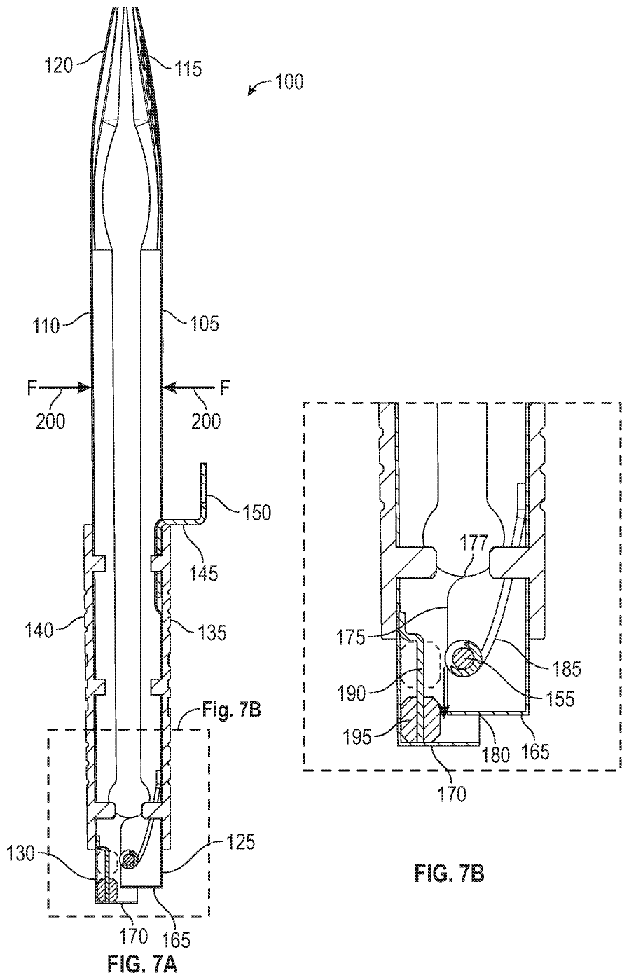

FIG. 6 displays a partially deconstructed side view of a disengaged, upside down, and open food handling apparatus 100. As shown, apparatus 100 has been flipped upside down in relation to apparatus 100 shown in FIGS. 5A and 5B. In this upside down and open configuration, retaining element 195 is shown engaged with first end 125. As compressive force 200 is applied to apparatus 100, as shown in FIGS. 7A and 7B, retaining element 195 may disengage from first end 125. With the help of gravity, retaining element 195 may move down track 190 to position itself adjacent an interior of second end 130. Once compressive force 200 is stopped, the linear force from spring mechanism 185 to arms 105,110 becomes more influential upon arms 105,110, which may pivot first end back into retaining element 195 (thus re-locking apparatus).

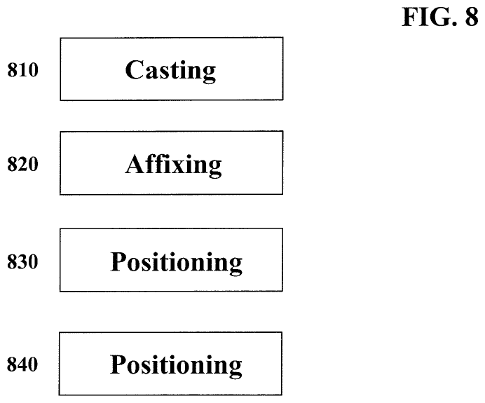

FIG. 8 displays a method 800 for producing a pair of tongs 100. Method 800 may include forming 810 a pair of arms 105,110 in a mold via at least one of casting (in a mold) and stamping (using tool and die methods). Each arm 105,110 of the pair of arms 105,110 being formed 810 may include one of a first end 125 and a second end 130 and a respective one of a first engagement member 115 and a second engagement member 120. In embodiments, forming 810 may include forming a flat bottom surface shape for the first and second ends 125,130. The pair of arms 105,110 may be affixed 820 together by a fastening device 155 at a pivot axis (positioned at fastening device 155 and spanning the width of the tongs 100) positioned adjacent the first end 125 and the second end 130. When formed 810, a respective one of the first and second arms 105,110 may be formed 810 with a length greater than the other of the respective other one of the first and second arms 105,110 so that one of the first end and second end 125,130 may engage retaining element 195 when arms 105,110 are pivoted. It is noted that the portion of the arms 105,110 that may be longer, in embodiments, may be one of the first and second ends 125,130 (the length in relation to the pivot axis).

Method 800 may further include positioning 830 a spring mechanism 185 about the pivot axis. Spring mechanism 185 may apply a linear force to the interior surfaces of first and second arms 105,110 so that arms 105,110 may pivot around pivot axis and ends 125,130 may pivot around pivot axis. Additionally, a pivot limiting mechanism may be positioned 840 within the pair of arms 105,110. Pivot limiting mechanism may include a respective one of the first and second ends 125,130, a track 190 affixed to an inner surface of a respective one of the first arm second arm 125,130, and a retaining element 195 positioned on track 190 that work in congruence to restrict pivoting movement of the first and second arm 125, 130.

It is noted that a respective one of the first arm 125 and the second arm 130 may be reversibly engageable with the pivot limiting mechanism contained within the pair of tongs 100. The ability for apparatus 100 to switch between a locked and unlocked state without the direct interaction of the user on the pivot limiting mechanism is advantageous to a user since there are no additional mechanical steps that need to be directed/physically actuated by the user (thus creating more simplicity).

It is noted that in embodiments, the positioning 830 may be carried out before positioning 840 is carried out. In other embodiments, positioning 840 may be carried out before positioning 830.

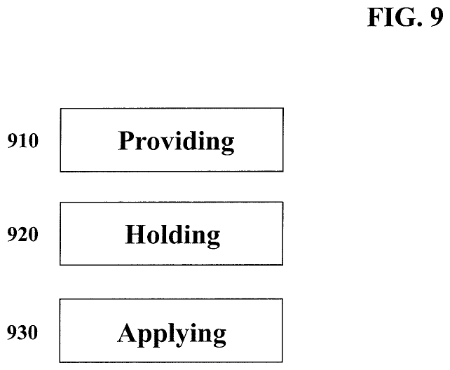

FIG. 9 displays a method 900 for locking a food handling apparatus 100. Method 900 may include providing 910 a food handling apparatus 100 having a first arm 105, a second min 110, and a spring mechanism 185 holding the first arm 105 and second arm 110 in tension. Each of the first arm 105 and the second arm 110 include an engagement member 115,120 and an end 125,130. the food handling apparatus 100 may then be held 920 by a user. When held 920 by a user, the user may point engagement members 115,120 upward and pair of ends 125,130 downward in relation to the ground. A compressive force may then be applied 930 to the first arm 105 and the second arm 110 opposite that of the tension force provided by the spring mechanism 185. In this instance, applying 930 the compression may allow a retaining element 195 to position itself in a locking position so that the pair of ends 125,130 compress and hold the retaining element 195 in place (positioned between an interior surface of one of the pair of ends 125,130 and an edge 167,172 of the other of the pair of ends 125,130). It is noted that the compression of retaining element 195 allows the food handling apparatus 100 to stay positioned in a locked position irrespective of how the food handling apparatus 100 is positioned thereafter and whether the compressive force is continually applied 930 to the first arm 125 and the second arm 130.

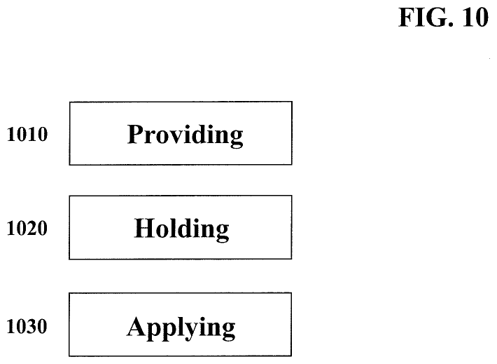

FIG. 10 displays a method 1000 for unlocking a food handling apparatus. Method 1000 may include providing 1010 a food handling apparatus 100 having a first arm 105, a second arm 110, and a spring mechanism 185 holding the first arm 105 and second arm 110 in tension. Each of the first arm 105 and the second arm 110 include an engagement member 115,120 and an end 125,130. Within the food handling apparatus 100, retaining element 195 is positioned in a locking position so that the pair of ends 125,130 compress and hold retaining element 195 in place (positioned between an interior surface of one of the pair of ends 125,130 and an edge 167,172 of the other of the pair of ends 125,130). the food handling apparatus 100 may then be held 1020 by a user. When held 1020 by a user, the user may point pair of ends 125,130 upward and engagement members 115,120 downward in relation to the ground. A compressive force may then be applied 1030 to the first arm 105 and the second arm 110 opposite that of the tension force provided by the spring mechanism 185. In this instance, applying 1030 the compression to the first and second arms 105,110 may disengage the pair of ends 105,110 from the retaining element 195. It is noted that the disengagement of retaining element 195 allows spring mechanism 185 to automatically position the food handling apparatus 100 in an open position irrespective of how the food handling apparatus 100 is positioned thereafter and whether the compressive force is continually applied 930 to the first arm 125 and the second arm 130.

In the aforementioned methods 800,900,1000, any of the steps described may be carried out in an order that is different than that disclosed.

In embodiments, the food handling apparatus 100 may be considered to be “oriented towards the ground” if a user is holding apparatus 100 with the pair of ends 125,130 pointing upward and the engagement members 115,120 pointing downward in relation to the ground. The food handling apparatus 100 may be “oriented away from the ground” if a user is holding apparatus 100 with the pair of ends 125,130 pointing downward and the engagement members 115,120 pointing upward in relation to the ground.

In embodiments, various attachment and fitting techniques and equipment (male-female engagement, fastening means, adhesives, welding, magnets) may be utilized in any of the disclosed embodiments in order for components of the embodiments to efficiently and/or properly attach to one another and so that the food handling apparatus 100 can efficiently and/or properly function. For example, the food handling apparatus 100 may comprise elements making up a pivoting locking mechanism, as opposed to a magnetic locking mechanism.

It is noted that in embodiments, the term “substantially contained” may refer to a respective one of the first end 125 and the second end 130, the track 190, and the retaining element 195 being contained within an interior of the first and second arms 105,110. It is further noted that this may include an understanding that one of the first end 125 and the second end 130 may be positioned below and positioned within the other of the first end 125 and the second end 130. In addition, in this context, each of the first end 125 and the second end 130 may refer to the interior surface of the first end 125 and the second end 130.

It is noted that in embodiments, each component of the pivot limiting mechanism may be referred to as being at least partially retained within the food handling apparatus 100.

In any of disclosed embodiments, the term “offset” may refer to the ends 125, 130 not matching in length based on the distance measured from aligned engagement members 115,120. It may additionally refer to the difference in length of ends 125,130 in relation to the pivot point of apparatus 100.

For the purposes of this disclosure, the terms “food handling apparatus”, “tongs”, “lockable tongs”, and “locking tongs” may be synonymous.

For the purposes of this disclosure, the terms “retaining element” and “pivot limiting mechanism” may be synonymous.

For the purposes of this disclosure, the terms “first arm” and “second arm” may be collectively referred to as a “pair of arms”.

A plurality of additional features and feature refinements are applicable to specific embodiments. These additional features and feature refinements may be used individually or in any combination. It is noted that each of the following features discussed may be, but are not necessary to be, used with any other feature or combination of features of any of the embodiments presented herein.

Unless otherwise defined, all technical and scientific terms used herein have the same meanings as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather, the scope of the present disclosure is defined by the appended claims and includes both combinations and sub-combinations of the various features described hereinabove as well as variations and modifications thereof, which would occur to persons skilled in the art upon reading the foregoing description.

I claim:

1. A food handling apparatus, comprising:
a first arm having a first end;
a second arm having a second end, the second arm affixed to the first end of the first arm at the second end via a fastening device;
a spring mechanism positioned between the first arm and the second arm, the spring mechanism applying a linear force to the first arm and the second arm;
a track affixed to at least one of an inner surface of a respective one of the first arm and the second arm and a respective one of the first end of the first arm and the second end of the second arm;
a retaining element positioned on the track; and
wherein the first end of the first arm and the second end of the second arm are offset from one another to allow a respective one of the first end of the first arm and the second end of the second arm to engage the retaining element when the respective one of the first end of the first arm and the second end of the second arm is pivoted toward the retaining element.

2. The apparatus of claim 1, further comprising a lower pivot area and an upper pivot area delineated by the fastening device.

3. The apparatus of claim 2, wherein engagement of the retaining element occurs in the lower pivot area.

4. The apparatus of claim 1, wherein each of the respective first arm and the first end and the respective second arm and the second end comprises a unitary body.

5. The apparatus of claim 1, wherein a respective one of the first end and the second end, the track, and the retaining element work in congruence as a pivot limiting mechanism to restrict pivoting movement of the first arm and the second arm.

6. The apparatus of claim 5, wherein each component of the pivot limiting mechanism are substantially contained within the food handling apparatus.

7. The apparatus of claim 5, wherein each component of the pivot limiting mechanism are at least partially retained within the food handling apparatus.

8. The apparatus of claim 1, wherein the respective one of the first end of the first arm and the second end of the second arm provides a compressive force to the retaining element to prevent movement of the retaining element.

9. The apparatus of claim 1, wherein the food handling apparatus is in a locked position when the respective one of the first end of the first arm and the second end of the second arm engages the retaining element.

10. The apparatus of claim 9, wherein the food handling apparatus is in the locked position when the respective one of the first end of the first arm and the second end of the second arm pivots toward the respective other one of the first end of the first arm and the second end of the second arm to press against the retaining element.

11. The apparatus of claim 1, wherein the first end and second end comprise a flat bottom surface.

12. A pair of tongs, comprising:
a first arm comprising a first end;
a second arm comprising a second end;
a fastening device, wherein the fastening device connects the first arm and second arm adjacent the first and second ends;
a spring mechanism positioned between the first arm and the second arm, the spring mechanism applying a linear force to the first arm and the second arm; and
an orientation-based locking mechanism positioned within the tongs, wherein at least one of the first end of the first arm and the second end of the second arm engages the orientation-based locking mechanism to prevent movement of the pair of tongs.

13. The tongs of claim 11, wherein a respective one of the first arm and the second arm is reversibly engageable with the orientation-based locking mechanism contained within the pair of tongs.

14. A method for producing a pair of tongs, comprising:
forming a pair of arms, wherein a respective one of the pair of arms comprises a first end and a respective other one of the pair of arms comprises a second end;
affixing the pair of arms together via a fastening device at a pivot axis, the fastening device positioned adjacent the first end and the second end; and
wherein a respective one of the first arm and second arm comprises a length greater than that of the respective other one of the first and second arms.

15. The method of claim 14, further comprising positioning a spring mechanism about the pivot axis, wherein the spring mechanism applies a linear force to the first arm and the second arm.

16. The method of claim 14, further comprising positioning a pivot limiting mechanism within the pair of arms, wherein the pivot limiting mechanism comprises a respective one of the first end and the second end, a track affixed to an inner surface of a respective one of the first arm and the second arm, and a retaining element positioned on the track that work in congruence to restrict pivoting movement of the first arm and the second arm.

17. The method of claim 14, wherein a respective one of the first end and the second end is longer than a respective other one of the first end and the second end in relation to the pivot axis.

18. The method of claim 14, wherein the forming further comprises providing a flat bottom surface shape for the first end and the second end.

19. A method for locking a food handling apparatus, comprising:
providing a food handling apparatus having a first arm, a second arm, and a spring mechanism holding the first arm and the second arm in tension, each of the first arm and the second arm comprising an engagement member and an end;
holding the food handling apparatus, wherein the pair of engagement members of the food handling apparatus are positioned above a pair of ends in relation to the ground;
applying a compressive force to the first arm and the second arm opposite that of the tension provided by the spring mechanism, wherein the compression of the first arm and the second arm allows a retaining element to position itself in a locking position so that the pair of ends compress and hold the retaining element in place; and
wherein the compression of the retaining element allows the food handling apparatus to stay positioned in a locked position irrespective of how the food handling apparatus is positioned thereafter and whether the compressive force is continually applied to the first arm and the second arm.

20. A method for unlocking a food handling apparatus, comprising:
providing a food handling apparatus having a first arm, a second arm, and a spring mechanism holding the first arm and the second arm in tension, each of the first arm and the second arm comprising an engagement member and an end, wherein the pair of ends engage a retaining element in order to keep the food handling apparatus in a locked position;
holding the food handling apparatus, wherein a pair of ends of the food handling apparatus are positioned above a pair of engagement members in relation to the ground;
applying a compressive force to the first arm and the second arm, wherein the compression of the first arm and the second arm disengages the pair of ends from the retaining element; and
wherein disengagement of the retaining element allows the spring mechanism to automatically position the food handling apparatus in an open position irrespective of how the food handling apparatus is positioned thereafter and whether the compressive force is continually applied to the first arm and the second arm.
